(19) United States
(12) Patent Application Publication
(10) Pub. No.: US 2012/0052377 A1
(43) Pub. Date: Mar. 1, 2012

(54) Energy storage device

(75) Inventors: Jun Hee Bae, Seoul (KR); Chang Ryul Jung, Seoul (KR); Bae Kyun Kim, Seongnam-si (KR); Yeong Su Cho, Guri-si (KR)

(73) Assignee: SAMSUNG ELECTRO-MECHANICS CO., LTD., Suwon (KR)

(21) Appl. No.: 12/926,736

(22) Filed: Dec. 7, 2010

(30) Foreign Application Priority Data
Aug. 26, 2010 (KR) 10-2010-0082927

(51) Int. Cl. H01M 10/26; H01G 9/02; H01G 9/045; H01G 9/145

(52) U.S. Cl. 429/207; 361/503; 361/505; 361/509

(57) ABSTRACT

Disclosed herein is an energy storage device. The energy storage device according to an exemplary embodiment of the present invention includes a case providing an internal space with a first space and a second space; an electrolyte solution filled in the internal space of the case; a positive electrode structure disposed on an interface between the first space and the second space and having a cathode active material layer including metal oxide composite; a first negative electrode disposed in the first space and having a first anode active material layer including graphite; and a second negative electrode disposed in the second space and having a second anode active material layer including activated carbon.

### CROSS REFERENCES TO RELATED APPLICATION

This application claims the benefit under 35 U.S.C. Section [120, 119, 119(e)] of Korean Patent Application Serial No. 10-2010-0082927, entitled “Energy Storage Device”, filed on Aug. 26, 2010, which is hereby incorporated by reference in its entirety into this application.

### BACKGROUND OF THE INVENTION

1. Technical Field

The present invention relates to an energy storage device, and more particularly, to an energy storage device with improved capacitance and output.

2. Description of the Related Art

Among next energy storage devices, a device called an ultra capacitor or a super capacitor has been in the limelight due to rapid charging/discharging rate, high stability, and environment-friendly characteristics. A general super capacitor is configured of an electrode structure, a separator, an electrolyte solution, and the like. The super capacitor is driven based on an electrochemical reaction mechanism that selectively absorbs carrier ions in the electrolyte solution to the electrode by applying power to the electrode structure. As representative super capacitors, an electric double layer capacitor (EDLC), a pseudocapacitor, a pseudocapacitor, a hybrid capacitor, and the like are currently used.

The electric double layer capacitor is a super capacitor which uses an electrode made of activated carbon and uses an electric double layer charging as a reaction mechanism. The pseudocapacitor is a super capacitor which uses a transition metal oxide or a conductive polymer as an electrode and uses pseudo-capacitance as a reaction mechanism. The hybrid capacitor is a super capacitor which has intermediate characteristics between the electric double layer capacitor and the pseudocapacitor.

However, the energy storage devices as described above have a relatively lower capacitance than a secondary battery. This reason is that most of the super capacitors as described above are driven by a charging/discharging mechanism using the movement of carrier ions on the interface between the electrode and the electrolyte and a chemical reaction on the surface of the electrode. At present, in an energy storage device such as a super capacitor, a need exists for a technology development for improving a relatively low capacitance.

### SUMMARY OF THE INVENTION

An object of the present invention is to provide an energy storage device with improved output and capacitance.

Another object of the present invention is to provide a hybrid type energy storage device in which an electrode structure implementing relatively high capacitance and an electrode structure implementing relatively high output are provided in a single cell.

Another object of the present invention is to provide a hybrid type energy storage device in which an energy storage structure using a reaction mechanism implementing relatively high capacitance and an energy storage structure using a reaction mechanism implementing relatively high output are provided in a single cell.

According to an exemplary embodiment of the present invention, there is provided an energy storage device, including: a case providing an internal space with a first space and a second space; an electrolyte solution filled in the internal space of the case; a positive electrode structure disposed on an interface between the first space and the second space and having a cathode active material layer including metal oxide composite; a first negative electrode disposed in the first space and having a first anode active material layer including graphite; and a second negative electrode disposed in the second space and having a second anode active material layer including activated carbon.

The positive electrode structure may further include a positive electrode collector of which surface is coated with the cathode active material layer, wherein the positive electrode collector is used as a partition wall partitioning the first space from the second space.

The positive electrode collector may include an aluminum foil.

The first negative electrode may further include a first negative electrode collector of which surface is coated with the first anode active material layer and the second negative electrode may further include a second negative electrode collector of which surface is coated with the second anode active material layer.

The first negative electrode collector may include a copper foil, and the second negative electrode collector may include an aluminum foil.

The electrolyte solution may include: a first electrolyte solution filled in the first space; and a second electrolyte solution filled in the second space, wherein at least one of the first electrolyte solution and the second electrolyte solution includes at least any one electrolyte salt of LiPF6, LiBF4, LiSbF6, LiAsF5, LiClO4, LiN, CF3SO3, LiC, LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi.

The electrolyte solution may include an aqueous solution filled in the second space.

The energy storage device may further include: a first separator disposed between the positive electrode structure and the first negative electrode; and a second separator disposed between the positive electrode structure and the second negative electrode.

According to an exemplary embodiment of the present invention, there is provided an energy storage device, including: a case providing an internal space with a first space and a second space; a first electrolyte solution filled in the first space and a second electrolyte solution filled in the second space; a positive electrode structure disposed on an interface between the first space and the second space and having a metal oxide layer; a first negative electrode disposed in the first space and having a first anode active material layer; and a second negative electrode disposed in the second space and having a second anode active material layer, wherein the first electrolyte solution includes first positive ions stored in the inside of the first anode active material layer by a charging reaction mechanism, and the second electrolyte solution includes second positive ions absorbed to the surface of the second anode active material layer by a charging reaction mechanism.

The charging reaction mechanism that absorbs the second positive ions to the surface of the second anode active material layer may include an oxidation-reduction reaction mechanism.

The first positive ions may include lithium (Li⁺) ions.

The second positive ions may include hydrogen (H⁺) ions.

The cathode active material layer may include metal oxide composite, the first anode active material layer may include graphite, and the second anode active material layer may include activated carbon.

The positive electrode structure may further include a positive electrode collector of which surface is coated with the cathode active material layer, wherein the positive electrode collector is used as a partition wall partitioning the first space from the second space.

The positive electrode structure and the first negative electrode may form an electrode structure of a lithium ion battery (LIB), and the positive electrode structure and the second negative electrode may form an electrode structure of a metal oxide composite capacitor.

The positive electrode structure may further include a positive electrode collector of which surface is coated with the cathode active material layer, the first negative electrode may further include a first negative electrode collector of which surface is coated with the first anode active material layer, and the second negative electrode may further include a second negative electrode collector of which surface is coated with the second anode active material layer, wherein the positive electrode collector includes an aluminum foil, the first negative electrode collector includes a copper foil, and the second negative electrode collector includes an aluminum foil.

### BRIEF DESCRIPTION OF THE DRAWINGS

FIG. 1 is a diagram showing an energy storage device according to an exemplary embodiment of the present invention;

FIG. 2 is a diagram for explaining a reaction mechanism when charging the energy storage device of FIG. 1; and

FIG. 3 is a diagram for explaining a reaction mechanism when discharging the energy storage device of FIG. 1.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals in the drawings denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, an energy storage device according to the present invention will be described in detail with reference to the accompanying drawings.

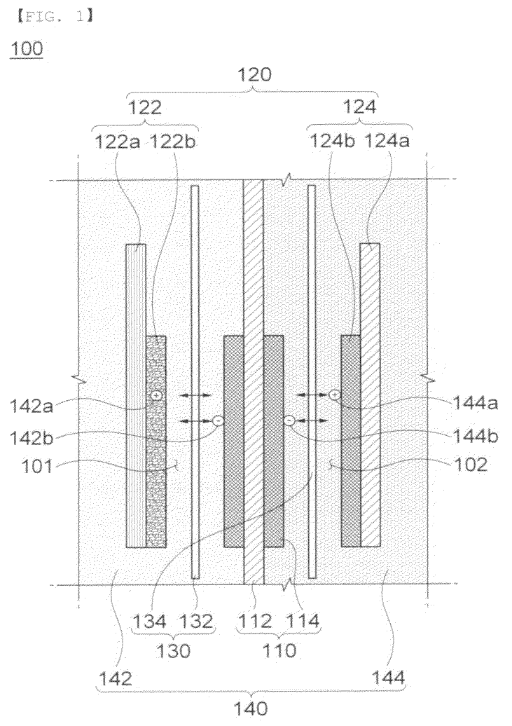

FIG. 1 is a diagram showing an energy storage device according to an exemplary embodiment of the present invention. Referring to FIG. 1, an energy storage device 100 according to an exemplary embodiment of the present invention may include an electrode structure, a separator 130, and an electrolyte solution 140.

The electrode structure may include a positive electrode structure 110 and a negative electrode structure 120. The positive electrode and negative electrode structures 110 and 120 may be disposed in a case (not shown). Portions of the positive electrode and negative electrode structures 110 and 120 may be selectively exposed to the outside of the case. The positive electrode structure 110 and the negative electrode structure 120 may exchange carrier ions, which are electrochemical reaction mediators, through the electrolyte solution 140.

The positive electrode structure 110 may be disposed to be opposite to the negative electrode structure 120, while having the separator 130 therebetween. The positive electrode structure 110 may be an electrode made of metal oxide composite. As an example, the positive electrode structure 110 may have a structure in which a metal oxide film containing metal ions such as a lithium transition metal is coated on the surface of a metal foil 112. As a metal foil for the positive electrode structure 110, an aluminum foil may be used.

Meanwhile, the positive electrode structure 110 may be used as a partition wall partitioning inner space of the energy storage device 100. For example, the positive electrode collector 112 may partition the case so that the inner space of the case is divided into two spaces. To this end, the positive electrode collector 112 may be provided to have a metal foil disposed so as to vertically cross the case. Therefore, the inner space of the case may be divided into a first space 101 and a second space 102, partitioned from each other, and the positive electrode collector 112 may be substantially disposed on the interface between the first space 101 and the second space 102.

The negative electrode structure 120 may include a first negative electrode 122 disposed on one side of the positive electrode structure 110 and a second negative electrode 124 disposed on the other side of the positive electrode structure 110 based on the positive electrode structure 110.

The first negative electrode 122 may be disposed in the first space 101. The first negative electrode 122 may include a first negative electrode collector 122a and a first anode active material layer 122b formed on the surface of the first negative electrode collector 122a. As the first negative electrode collector 122a, various kinds of metal foils may be used and the first anode active material layer 122b may be formed by coating the surface of the metal foil with a first anode active material. As an example, as the first negative electrode collector 122a, a copper foil may be used and as the first anode active material layer 122b, a thin film made of graphite may be used.

The second negative electrode 124 may be disposed in the second space 102. The second negative electrode 124 may include a second negative electrode collector 124a and a second anode active material layer 124b formed on the surface of the second negative electrode collector 124a. As the second negative electrode collector 124a, various kinds of metal foils may be used and the second anode active material layer 124b may be formed by coating the surface of the metal foil with a second anode active material. As an example, as the second negative electrode collector 124a, an aluminum foil may be used and as the second anode active material layer 124b, a thin film made of active carbon may be used.

The separator 130 may be selectively disposed between the positive electrode structure 110 and the negative electrode structure 120. As an example, the separator 130 may include a first separator 132 disposed in the first space 101 and a second separator 134 disposed in the second space 102. The first separator 132 may be disposed between the positive electrode structure 110 and the first negative electrode 122, thereby making it possible to partition the positive electrode structure 110 from the first negative electrode 122. Similarly, the second separator 134 may be disposed between the positive electrode structure 110 and the second negative electrode 124, thereby making it possible to partition the positive electrode structure 110 from the second negative electrode 124. As the separator 130, at least any one of nonwoven fabric, polytetrafluorethylene (PTFE), a porous film, a craft fiber, a cellulosic electrolytic paper, rayon fiber, and other various kinds of sheets may be used.

The electrolyte solution 140 may be filled in the case. The electrolyte solution 140 may include positive ions and negative ions, which are moving mediators between the positive electrode structure 110 and the negative electrode structure 120. The electrolyte solution 140 may be a composition prepared by melting electrolyte salt in a predetermined solvent. For example, the electrolyte solution 140 may include a first electrolyte solution 142 filled in the first space 101 and a second electrolyte solution 144 filled in the second space 102.

The first electrolyte solution 142 may be a composition prepared by melting first electrolyte salt in the solvent. The first electrolyte salt may have first positive ions 142a stored in the inside of the first anode active material layer 122b of the first negative electrode 122 by a charging reaction mechanism. As the first electrolyte salt, lithium-based electrolyte salt may be used. The lithium-based electrolyte salt may be salt including lithium (Li⁺) ions as carrier ions between the positive electrode structure 110 and the first negative electrode 122 at the time of charging and discharging operations of the energy storage device 100. For example, the lithium-based electrolyte salt may include at least any one of LiPF6, LiBF4, LiSbF6, LiAsF5, LiClO4, LiN, CF3SO3, and LiC. Alternatively, the lithium-based electrolyte salt may include at least any one of LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi. In this case, the positive electrode structure 110 and the first negative electrode 122 may be driven by the charging/discharging mechanism of the lithium ion battery.

The second electrolyte solution 144 may be the same as the first electrolyte solution 142. In other words, the second electrolyte solution 144 may be a composition prepared by melting lithium-based electrolyte salt. In this case, the positive electrode structure 110 and the second negative electrode 124 may be driven by the charging/discharging mechanism of the hybrid capacitor.

Alternatively, the second electrolyte solution 144 may be different from the first electrolyte solution 142. For example, the second electrolyte solution 144 may be an aqueous solution having positive ions (for example, hydrogen ions H⁺), which are mediators of oxidation-reduction reaction, on an interface with the positive electrode structure 110. In this case, the positive electrode structure 110 and the second negative electrode 124 may be driven by the charging/discharging mechanism of the pseudocapacitor.

The solvent of the first and second electrolyte solution may include at least any one of annular carbonate and linear carbonate. For example, as the annular carbonate, at least any one of ethylene carbonate (EC), propylene carbonate (PC), butylene carbonate (BC), and vinyl ethylene carbonate (VEC) may be used. As the linear carbonate, at least any one of dimethyl carbonate (DMC), methyl ethyl carbonate (MEC), diethyl carbonate (DEC), methyl propyl carbonate (MPC), dipropyl carbonate (DPC), metylbutyl carbonate (MBC), and dibutyl carbonate (DBC) may be used. Various kinds of ether, ester, and amide-based solvent may also be used.

As described above, the energy storage device 100 according to the exemplary embodiment of the present invention may have a structure of a hybrid type super capacitor in which a single positive electrode structure 110 and two first and second negative electrodes 122 and 124 are provided in a single cell to be operated in each different reaction mechanism. For example, an electrode structure configured of the positive electrode structure 110 and the first negative electrode 122, that is, an electrode structure of a lithium ion battery (LIB), may be provided in the first space 101 of the energy storage device 100 and an electrode structure configured of the positive electrode structure 110 and the second negative electrode 124, that is, an electrode structure of a metal oxide composite, may be provided in the second space 102 of the energy storage device 100. The metal oxide composite capacitor may be an energy storage device, which is called the pseudocapacitor and the hybrid capacitor using a metal oxide composite as a positive electrode. Herein, the electrode structure of the lithium ion battery can implement higher capacitance as compared to the electrode structure of the metal oxide composite capacitor. On the other hand, the electrode structure of the metal oxide composite capacitor can implement higher output as compared to the electrode structure of the lithium ion battery. Therefore, the energy storage device 100 according to the present invention has a single cell in which the electrode structure implementing relatively higher capacitance and the electrode structure implementing relatively higher output are provided, thereby making it possible to have a structure of a hybrid type super capacitor with improved output and capacitance.

Continuously, charging and discharging mechanisms of the energy storage device according to the exemplary embodiment of the present invention will be described in detail. Herein, a description overlapping with the energy storage device 100 described above may be omitted or simplified.

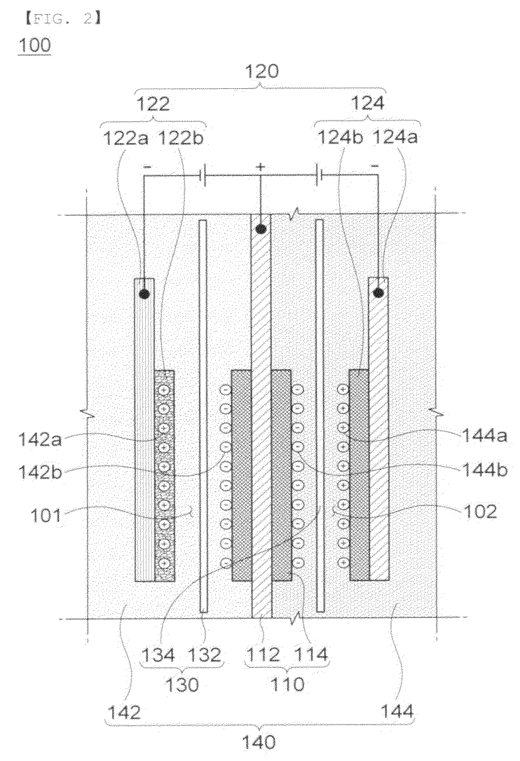

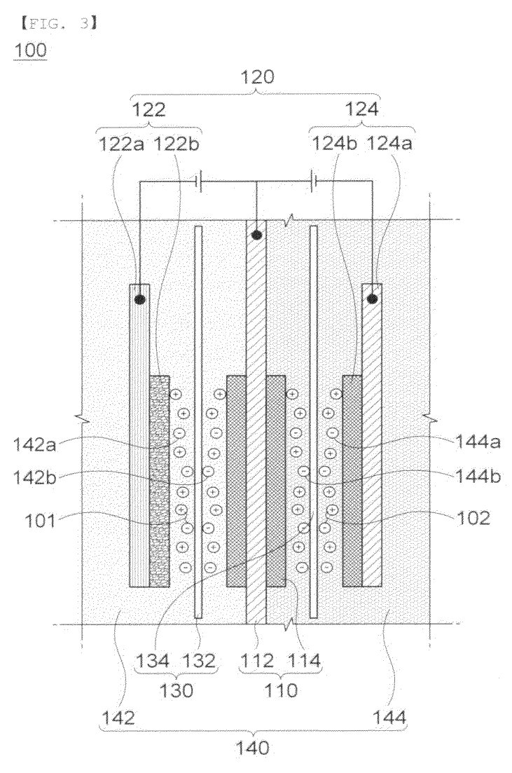

FIG. 2 is a diagram for explaining a reaction mechanism when charging the energy storage device of FIG. 1 and FIG. 3 is a diagram for explaining a reaction mechanism when discharging the energy storage device of FIG. 1.

Referring to FIGS. 2 and 3, when a charging operation of the energy storage device 100 according to the present invention starts, the charging thereof may be simultaneously performed from a first electrode structure configured of the positive electrode structure 110 and the first negative electrode 122 and a second electrode structure configured of the positive electrode structure 110 and the second negative electrode 124. More specifically, positive power may be applied to a positive electrode collector 112 of the positive electrode structure 110 and negative power may be applied to a first negative electrode collector 122a of the first negative electrode 122. Therefore, positive ions 142a in the first electrolyte solution 142 may be stored in the inside of a first anode active material layer 122b of the first negative electrode 122, and negative ions 142b therein may be absorbed to the surface of a cathode active material layer 114 of the positive electrode structure 110. That is, a charging reaction mechanism that stores the positive ions 142a in the first electrolyte solution 142 in the inside of the first anode active material layer 122b may be implemented in a first space 101 of the energy storage device 100. At the same time, positive ions 144a in the second electrolyte solution 144 may be absorbed to the surface of a second anode active material layer 124b of the second negative electrode 124, and negative ions 144b therein may be absorbed to the surface of a cathode active material layer 114 of the positive electrode structure 110. That is, a charging reaction mechanism that absorbs the positive ions 144a in the second electrolyte solution 144 to the surface of the second anode active material layer 124b may be implemented in a second space 102 of the energy storage device 100.

Herein, the first electrode structure forms the electrode structure of the lithium ion battery (LIB), thereby making it possible to implement relatively higher capacitance as compared to the second electrode structure forming the electrode structure of the metal oxide composite capacitor. Therefore, the energy storage device 100 supplements the second electrode structure having relatively low capacitance, thereby making it possible to further improve capacitance by the first electrode structure.

When the charging operation is completed, power applied to the positive electrode structure 110 and the negative electrode structure 120 of the energy storage device 100 may be stopped. Then, the energy storage device 100 is used. Herein, the output of the energy storage device 100 may be simultaneously performed from the first electrode structure and the second electrode structure. At this time, the second electrode structure may implement higher output as compared to the first electrode structure. Therefore, the energy storage device 100 supplements the first electrode structure having relatively low output, thereby making it possible to further improve output by the second electrode structure.

As described above, the energy storage device 100 according to the present invention may operate in the first space 101 by the lithium ion battery (LIB) reaction mechanism that lithium (Li⁺) ions between the cathode active material layer 114 and the first anode active material layer 122b are used as carrier ions, and may operate in the second space 102 by the oxidation-reduction reaction mechanism that nonlithium ions (for example, ammonium (NH₄⁺) ions) between the cathode active material layer 114 and the second anode active layer 124b are used as carrier ions. Therefore, in the energy storage device 100 according to the present invention, the charging/discharging mechanism implementing relatively high capacitance and the charging/discharging mechanism implementing relatively high output are mutually supplemented to be driven in a single cell, thereby making it possible to have a structure with improved capacitance and output.

In the energy storage device according to the present invention, a single positive electrode structure and two negative electrodes are provided in a single cell, thereby making it possible to have a structure of a hybrid type super capacitor in which they operate using different charging and discharging reaction mechanisms. Therefore, the energy storage device according to the present invention may have the structure of the hybrid type super capacitor in which different electrode structures of the super capacitor are provided in a single cell.

The energy storage device according to the present invention may include a single common positive electrode structure, a first negative electrode forming an electrode structure of a secondary battery together with the common positive electrode structure, and a second negative electrode forming an electrode structure of a metal oxide composite capacitor together with the common positive electrode structure. Therefore, the energy storage device according to the present invention has the electrode structure of the secondary battery implementing relatively high capacitance and the electrode structure of the super capacitor implementing relatively high output, thereby making it possible to have a structure with improved capacitance and output.

The energy storage device according to the present invention may include a single common positive electrode structure, a first negative electrode, and a second negative electrode provided in a single cell, wherein the first negative electrode has a reaction mechanism capable of implementing relatively high capacitance together with the positive electrode structure, and the second negative electrode has a reaction mechanism capable of implementing relatively high output together with the positive electrode structure. Therefore, in the energy storage device according to the present invention, the reaction mechanism implementing relatively high capacitance and the reaction mechanism implementing relatively high output are supplemented and driven in a single cell, thereby making it possible to have a structure with improved capacitance and output.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An energy storage device, comprising:
a case providing an internal space with a first space and a second space;
an electrolyte solution filled in the internal space of the case;
a positive electrode structure disposed on an interface between the first space and the second space and having a cathode active material layer including metal oxide composite;
a first negative electrode disposed in the first space and having a first anode active material layer including graphite; and
a second negative electrode disposed in the second space and having a second anode active material layer including activated carbon.

2. The energy storage device according to claim 1, wherein the positive electrode structure further includes a positive electrode collector of which surface is coated with the cathode active material layer, the positive electrode collector being used as a partition wall partitioning the first space from the second space.

3. The energy storage device according to claim 2, wherein the positive electrode collector includes an aluminum foil.

4. The energy storage device according to claim 1, wherein the first negative electrode further includes a first negative electrode collector of which surface is coated with the first anode active material layer and the second negative electrode further includes a second negative electrode collector of which surface is coated with the second anode active material layer.

5. The energy storage device according to claim 4, wherein the first negative electrode collector includes a copper foil, and the second negative electrode collector includes an aluminum foil.

6. The energy storage device according to claim 1, wherein the electrolyte solution includes:
a first electrolyte solution filled in the first space; and
a second electrolyte solution filled in the second space,
at least one of the first electrolyte solution and the second electrolyte solution including at least any one electrolyte salt of LiPF6, LiBF4, LiSbF6, LiAsF5, LiClO4, LiN, CF3SO3, LiC, LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi.

7. The energy storage device according to claim 1, wherein the electrolyte solution includes an aqueous solution filled in the second space.

8. The energy storage device according to claim 1, further comprising:
a first separator disposed between the positive electrode structure and the first negative electrode; and
a second separator disposed between the positive electrode structure and the second negative electrode.

9. An energy storage device, comprising:
a case providing an internal space with a first space and a second space;
a first electrolyte solution filled in the first space and a second electrolyte solution filled in the second space;
a positive electrode structure disposed on an interface between the first space and the second space and having a metal oxide layer;
a first negative electrode disposed in the first space and having a first anode active material layer; and
a second negative electrode disposed in the second space and having a second anode active material layer,
wherein the first electrolyte solution includes first positive ions stored in the inside of the first anode active material layer by a charging reaction mechanism, and
the second electrolyte solution includes second positive ions absorbed to the surface of the second anode active material layer by a charging reaction mechanism.

10. The energy storage device according to claim 9, wherein the charging reaction mechanism that absorbs the second positive ions to the surface of the second anode active material layer includes an oxidation-reduction reaction mechanism.

11. The energy storage device according to claim 9, wherein the first positive ions include lithium (Li⁺) ions.

12. The energy storage device according to claim 9, wherein the second positive ions include hydrogen (H⁺) ions.

13. The energy storage device according to claim 9, wherein the cathode active material layer includes metal oxide composite,
the first anode active material layer includes graphite, and
the second anode active material layer includes activated carbon.

14. The energy storage device according to claim 9, wherein the positive electrode structure further includes a positive electrode collector of which surface is coated with the cathode active material layer, the positive electrode collector being used as a partition wall partitioning the first space from the second space.

15. The energy storage device according to claim 9, wherein the positive electrode structure and the first negative electrode form an electrode structure of a lithium ion battery (LIB), and
the positive electrode structure and the second negative electrode form an electrode structure of a metal oxide composite capacitor.

16. The energy storage device according to claim 9, wherein the positive electrode structure further includes a positive electrode collector of which surface is coated with the cathode active material layer,
the first negative electrode further includes a first negative electrode collector of which surface is coated with the first anode active material layer, and
the second negative electrode further includes a second negative electrode collector of which surface is coated with the second anode active material layer,
the positive electrode collector including an aluminum foil,
the first negative electrode collector including a copper foil, and
the second negative electrode collector including an aluminum foil.
